(19) United States
(12) Patent Application Publication
(10) Pub. No.: US 2025/0119841 A1
(43) Pub. Date: Apr. 10, 2025

(54) METHOD FOR PERFORMING MAPPING BETWEEN ONE OR MORE RADIO MODULES AND ONE OR MORE RADIOFREQUENCY GROUPS AND ASSOCIATED ELECTRONIC DEVICE

(71) Applicant: MEDIATEK INC., Hsinchu City (TW)

(72) Inventors: Tsung-Po Yu, Hsinchu City (TW); Yi-Hsuan Lin, Hsinchu City (TW); Fu-Tse Kao, Hsinchu City (TW)

(73) Assignee: MEDIATEK INC., Hsinchu City (TW)

(21) Appl. No.: 18/902,964

(22) Filed: Oct. 1, 2024

Related U.S. Application Data
(60) Provisional application No. 63/587,757, filed on Oct. 4, 2023.

(51) Int. Cl. H04W 52/22; H04B 17/10; H04B 17/20; H04W 52/36

(52) U.S. Cl. CPC H04W 52/221; H04B 17/102; H04B 17/202; H04W 52/367

(57) ABSTRACT

A method for performing mapping between one or more radio modules and one or more radiofrequency (RF) groups includes: separating the one or more radio modules into the one or more RF groups according to one or more messages, wherein the one or more messages comprise a previous TX power ratio, a TX power ratio margin, one or more weighting information, one or more TX performance indices, one or more receiving (RX) performance indices, one or more configurations, or one or more usage scenarios; accumulating RF exposure of the one or more radio modules to at least one RF group among the one or more RF groups; and determining at least one transmitting (TX) power limit corresponding to the at least one RF group according to accumulated RF exposure of the at least one RF group.

### CROSS REFERENCE TO RELATED APPLICATIONS

This application claims the benefit of U.S. Provisional Application No. 63/587,757, filed on Oct. 4, 2023. The content of the application is incorporated herein by reference.

### BACKGROUND

The present invention is related to radio frequency (RF) technology, and more particularly, to a method for performing mapping between one or more radio modules and one or more radiofrequency (RF) groups, and an associated electronic device.

Nowadays, the RF technology has often appeared in a user equipment (UE; such as a mobile phone). However, excessive RF exposure may cause harm to human body. As a result, officials of different countries (e.g. federal communications commission (FCC) of USA, innovation, science, and economic development (ISED) of Canada, and conformite europeenne (CE) of Europe) regulate a time-averaged RF exposure limit to limit a time-averaged RF exposure of a radio module in the UE. For example, in response to a frequency band of the radio module being smaller than 6 GHz, the time-averaged RF exposure will be quantified with a time-averaged specific absorption rate (SAR), and in response to the frequency band of the radio module being not smaller than 6 GHz, the time-averaged RF exposure will be quantified with a time-averaged power density (PD). In addition, since the time-averaged RF exposure will be proportional to a transmitting (TX) power of the radio module, the time-averaged RF exposure can meet the time-averaged RF exposure limit by controlling the TX power.

For simultaneous multi-radio access technology (multi-RAT) transmission (e.g. 2G, 3G, 4G, 5G, non-terrestrial networks (NTN), wireless fidelity (Wi-Fi), and Bluetooth (BT)), the officials regulate that a total exposure ratio (TER) must be less than or equal to 1 (i.e. TER≤1). For example, the TER may be calculated by combining normalized values of measurement results regarding SAR (e.g., values obtained by dividing each measurement result by a corresponding regulation limit). In addition, under a situation that some conditions are met, the radio modules can be grouped according to a predetermined regulation (e.g., a specific absorption rate to peak location separation ratio (SPLSR) regulation) in order to obtain multiple RF groups, wherein SAR calculation for each RF group is independent. Some problems may occur, however. While different body parts may have different RF exposure limits, the existing method may result in poor performance in some scenarios due to the combined RF exposure of all body parts. As a result, a novel method for performing mapping between one or more radio modules and one or more RF groups and an associated electronic device are urgently needed.

### SUMMARY

It is therefore one of the objectives of the present invention to provide a method for performing mapping between one or more radio modules and one or more RF groups, and an associated electronic device, in order to address the above-mentioned issues.

According to an embodiment of the present invention, a method for performing mapping between one or more radio modules and one or more RF groups is provided, wherein the one or more radio modules correspond to one or more antennas of an electronic device, respectively. The method comprises: separating the one or more radio modules into the one or more RF groups according to one or more messages, wherein the one or more messages comprise a previous TX power ratio, a TX power ratio margin, one or more weighting information, one or more TX performance indices, one or more receiving (RX) performance indices, one or more configurations, or one or more usage scenarios; accumulating RF exposure of the one or more radio modules to at least one RF group among the one or more RF groups; and determining at least one TX power limit corresponding to the at least one RF group according to accumulated RF exposure of the at least one RF group, for determining at least one TX power limit of at least one antenna among the one or more antennas.

According to an embodiment of the present invention, an electronic device is provided. The electronic device comprises one or more antennas, one or more radio modules, and a processing circuit. The one or more radio modules correspond to the one or more antennas, respectively. The processing circuit is arranged to perform mapping between the one or more radio modules and one or more RF groups. In addition, the processing circuit is further arranged to: separate the one or more radio modules into the one or more RF groups according to one or more messages, wherein the one or more messages comprise a previous TX power ratio, a TX power ratio margin, one or more weighting information, one or more TX performance indices, one or more receiving (RX) performance indices, one or more configurations, or one or more usage scenarios; accumulate RF exposure of the one or more radio modules to at least one RF group among the one or more RF groups; and determine at least one TX power limit corresponding to the at least one RF group according to accumulated RF exposure of the at least one RF group, for determining at least one TX power limit of at least one antenna among the one or more antennas.

One of the benefits of the present invention is that, by the method of the present invention and an associated electronic device, both the mapping between radio modules and RF groups and the RF exposure accumulation of the RF groups can be performed according to different body parts, which can optimize the performance of each RF group and guarantee the compliance of each RF group with RF exposure regulations. In addition, the radio modules may also be dynamically separated into the RF groups according to usage information of the electronic device, which can further optimize the performance of each RF group.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating an example of radio module grouping according to an embodiment of the present invention.

FIG. 3 is a diagram illustrating an example of RF exposure accumulation regarding RF sub-groups shown in FIG. 2 according to an embodiment of the present invention.

FIG. 4 is a flow chart of a method for performing mapping between one or more radio modules and one or more RF groups according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

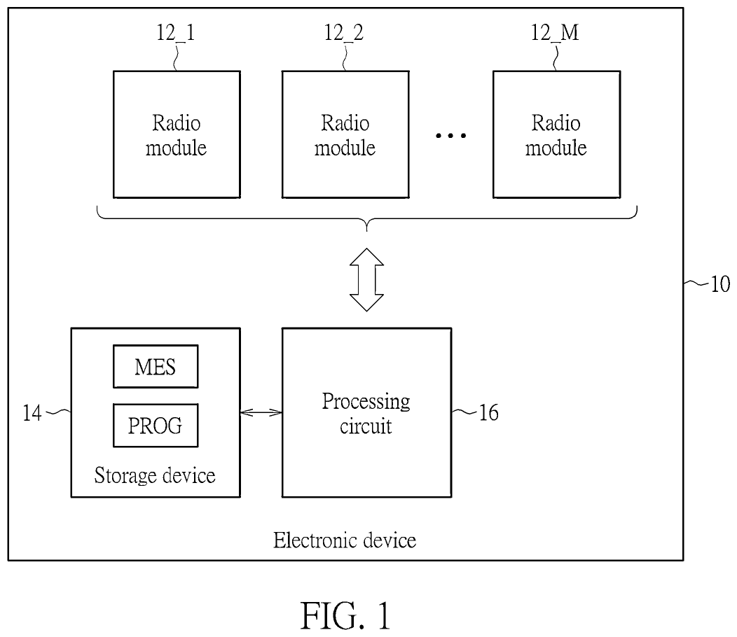

FIG. 1 is a diagram illustrating an electronic device 10 according to an embodiment of the present invention. By way of example, but not limitation, the electronic device 10 may be a portable device such as a smartphone, a wearable device, or a tablet. As shown in FIG. 1, the electronic device 10 may include multiple radio modules 12_1-12_M, a storage device 14, and a processing circuit 16, wherein “M” is a positive integer greater than one (i.e., M≥2). Each of the radio modules 12_1-12_M may include communication circuits corresponding to 2G, 3G, 4G, 5G, wireless fidelity (Wi-Fi), Bluetooth (BT), and/or non-terrestrial networks (NTN), and may support multi-radio access technology (multi-RAT) transmission with aid of the communication circuits, but the present invention is not limited thereto. In addition, each of the radio modules 12_1-12_M may correspond to an antenna for transceiving radiofrequency (RF) signals.

The storage device 14 is a non-transitory machine-readable medium, and is arranged to store computer program code PROG. The electronic device 10 may be regarded as a computer system using a computer program product that includes a computer-readable medium containing the computer program code PROG. The processing circuit 16 is equipped with software execution capability. When loaded and executed by the processing circuit 16, the computer program code PROG instructs the processing circuit 16 to perform grouping operation upon one or more radio modules among the radio modules 12_1-12_M, and more particularly, to perform mapping between one or more radio modules and one or more RF groups.

Specifically, the processing circuit 16 may dynamically separate one or more radio modules among the radio modules 12_1-12_M into one or more RF groups according to one or more messages MES stored in the storage device 14, wherein the one or more messages MES may include some information of each radio module. By way of example, but not limitation, the information of the radio module may include a previous transmitting (TX) power ratio, a TX power ratio margin, one or more weighting information, one or more TX performance indices, one or more receiving (RX) performance indices, and one or more configurations. For example, the processing circuit 16 may be arranged to receive the one or more weighting information from a user or different scenarios for allocating TX power ratios of the radio modules 12_1-12_M, and store the one or more weighting information in the storage device 14. In addition, the one or more messages MES may further include an antenna configuration ANT_CON, wherein the antenna configuration ANT_CON may be related to a predetermined regulation (e.g., a specific absorption rate to peak location separation ratio (SPLSR) regulation).

The one or more TX performance indices may include at least one of a duty cycle of TX, an error vector magnitude (EVM) of TX, a target power, a throughput, a modulation and coding scheme (MCS), a block error rate (BLER), a resource block (RB), a transmission block size (TBS), and a TX packet error rate (TX PER).

The one or more RX performance indices may include at least one of a duty cycle of RX, the MCS, a received signal strength indication (RSSI), a reference signal receiving power (RSRP), a signal to noise ratio (SNR), a signal-to-interference-plus-noise ratio (SINR), and an RX packet error rate (RX PER).

The one or more configurations may be related to at least one of one or more body-parts BODY_PAR, a band, a beam, a technology, a sub-band, one or more exposure condition indices, a simultaneous transmitted state, a mobile country code (MCC), a mobile network code (MNC), a modulation, a bandwidth, a maximum power reduction (MPR), a path, a duty cycle, and a combination of the band and an subscriber identity module (SIM).

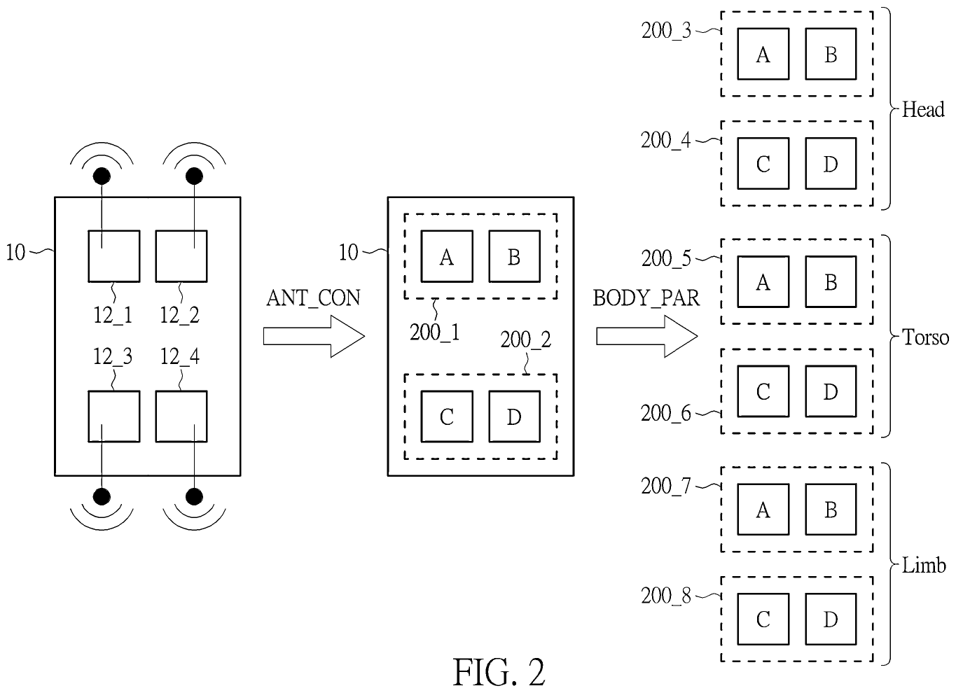

Take the one or more configurations related to the one or more body-parts BODY_PAR as examples. FIG. 2 is a diagram illustrating an example of radio module grouping according to an embodiment of the present invention. As shown in FIG. 2, assume that the electronic device 10 includes the radio modules 12_1-12_4 (M=4), and each radio module corresponds to an antenna for transceiving RF signals. In the beginning, the processing circuit 16 may separate the radio modules 12_1-12_4 into two RF groups 200_1 and 200_2 according to the antenna configuration ANT_CON, and more particularly, may separate the radio modules 12_1 and 12_2 into the RF group 200_1, and separate the radio modules 12_3 and 12_4 into the RF group 200_2. For brevity, the radio modules 12_1-12_4 in the RF groups 200_1 and 200_2 are labeled as “A”, “B”, “C”, and “D”, respectively.

Examples of the one or more body-parts BODY_PAR may include, but are not limited to: a head, a torso, and a limb. The processing circuit 16 may be further arranged to separate the RF groups 200_1 into the RF sub-groups 200_3, 200_5, and 200_7 according to the one or more body-parts BODY_PAR, and separate the RF groups 200_2 into the RF sub-groups 200_4, 200_6, and 200_8 according to the one or more body-parts BODY_PAR, wherein the RF sub-groups 200_3 and 200_4 correspond to the head, the RF sub-groups 200_5 and 200_6 correspond to the torso, and the RF sub-groups 200_7 and 200_8 correspond to the limb. However, this is for illustrative purposes only, and is not meant to be a limitation of the present invention. In some embodiments, the processing circuit 16 may firstly separate the radio modules 12_1-12_4 into the RF groups according to the one or more body-parts BODY_PAR, and then separate the RF groups into the RF sub-groups according to the antenna configuration ANT_CON. In some embodiments, the processing circuit 16 may only separate the radio modules 12_1-12_4 into the RF groups according to the one or more body-parts BODY_PAR. These alternative designs all fall within the scope of the present invention.

After the radio modules 12_1-12_M are separated into one or more RF groups, the processing circuit 16 may accumulate RF exposure of at least one radio module among the radio modules 12_1-12_M to at least one RF group among the one or more RF groups. Take the one or more configurations related to the one or more body-parts BODY_PAR as examples. The one or more messages MES may further include some information related to the detected position of the electronic device 10, and the processing circuit 16 may determine which of the one or more body parts BODY_PAR is close to the electronic device 10 based on the information. As a result, the processing circuit 16 may determine at least one active body part from the one or more body parts BODY_PAR according to the one or more messages MES, and accumulate the RF exposure to at least one active RF group corresponding to the at least one active body part, wherein the at least one active RF group is included in the one or more RF groups.

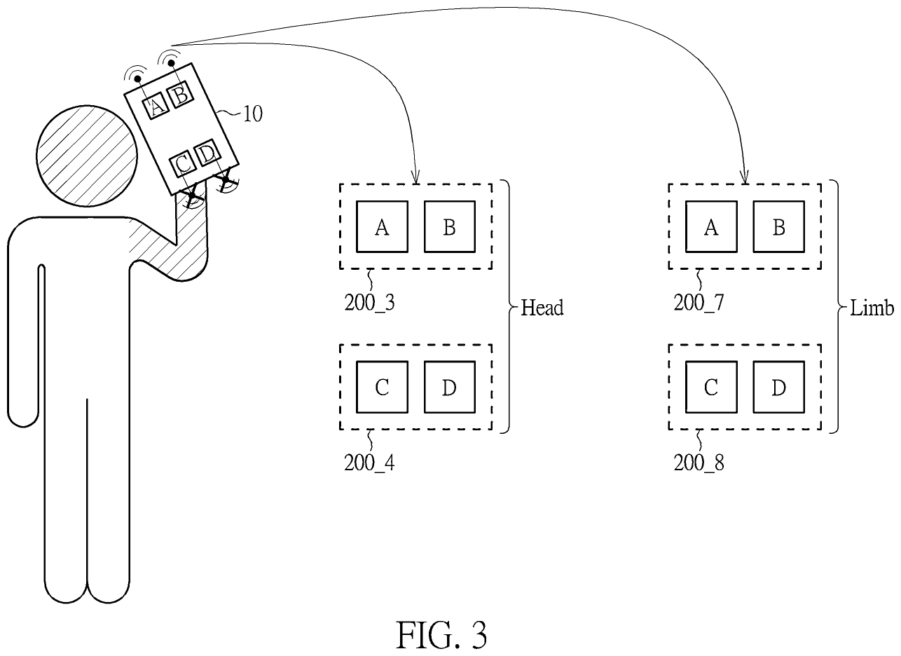

FIG. 3 is a diagram illustrating an example of RF exposure accumulation regarding the RF sub-groups 200_3-200_8 shown in FIG. 2 according to an embodiment of the present invention. Under a situation that the one or more body-parts BODY_PAR include the head, the torso, and the limb, in response to the one or more messages MES indicating that the head and the limb are close to the electronic device 10 (e.g., a user holds the electronic device 10 towards the head), the processing circuit 16 may determine the head and the limb as the active body parts, and determine the torso as an inactive body part. That is, the processing circuit 16 may determine the RF sub-groups 200_3 and 200_4 corresponding to the head and the RF sub-groups 200_7 and 200_8 corresponding to the limb as the active RF groups, and determine the RF sub-groups 200_5 and 200_6 corresponding to the torso as inactive RF groups. In addition, assume that only antennas corresponding to the radio modules 12_1 and 12_2 (denoted by “A” and “B” in FIG. 3, respectively) are operating, and may be regarded as active antennas. As a result, the processing circuit 16 may simultaneously and separately accumulate the RF exposure caused by the active antennas to the RF sub-groups 200_3 and 200_7. In some embodiments, when the user holds the electronic device 10 towards the torso (i.e., the one or more messages MES indicates that the torso and the limb are close to the electronic device 10), the processing circuit 16 may determine the torso and the limb as the active body parts, and determine the head as an inactive body part.

In addition, the processing circuit 16 may determine/calculate a TX power limit of each of the RF sub-groups 200_3 and 200_7 according to accumulated RF exposure of said each RF sub-group, in order to ensure that the one or more body-parts BODY_PAR (more particularly, the head and the limb) can meet the RF exposure regulations. For example, the processing circuit 16 may receive multiple time-averaged RF exposure limits TEL_1 and TEL_2 regulated by officials (for brevity, hereinafter denoted by “RF exposure limit”), wherein the RF exposure limits TEL_1 and TEL_2 correspond to the RF sub-groups 200_3 and 200_7, respectively. Since RF exposure of the RF sub-group 200_3 is proportional to a TX power of the RF sub-group 200_3, the processing circuit 16 may be further arranged to map the RF exposure limit TEL_1 to a TX power limit TPL1 of the RF sub-group 200_3. Specifically, the RF exposure limit TEL_1 may be a total exposure ratio (TER), wherein the TER may include a normalized average specific absorption rate (SAR) limit, and the TER is required to be less than or equal to 1 (i.e. TER≤1). The processing circuit 16 may utilize a test or a simulation to find a normalized average TX power limit mapped to the normalized average SAR limit, wherein the TX power limit TPL1 includes the normalized average TX power limit. However, this is for illustration only, and the present invention is not limited thereto. In some embodiments, the user may directly utilize the test or the simulation to find the TX power limit TPL1. That is, the RF exposure limit TEL_1 may also be mapped to the TX power limit TPL1 of the RF sub-group 200_3 directly by the user.

Afterwards, the processing circuit 16 may adjust the TX power limit TPL1 according to the accumulated RF exposure of the RF sub-group 200_3, in order to determine an adjusted TX power limit ATPL1 of the RF sub-group 200_3.

After determining the adjusted TX power limit ATPL1, the processing circuit 16 may control an instantaneous power of the RF sub-group 200_3 to make an average power of the RF sub-group 200_3 lower than or equal to the adjusted TX power limit ATPL1, in order to comply with regulations of the RF exposure limit TEL_1.

Similarly, since RF exposure of the RF sub-group 200_7 is proportional to a TX power of the RF sub-group 200_7, the processing circuit 16 may be further arranged to map the RF exposure limit TEL_2 to a TX power limit TPL2 of the RF sub-group 200_7. Specifically, the RF exposure limit TEL_2 may be the TER, wherein the TER may include a normalized average SAR limit. The processing circuit 16 may utilize a test or a simulation to find a normalized average TX power limit mapped to the normalized average SAR limit, wherein the TX power limit TPL2 includes the normalized average TX power limit. However, this is for illustration only, and the present invention is not limited thereto. In some embodiments, the user may directly utilize the test or the simulation to find the TX power limit TPL2. That is, the RF exposure limit TEL_2 may also be mapped to the TX power limit TPL2 of the RF sub-group 200_7 directly by the user.

Afterwards, the processing circuit 16 may adjust the TX power limit TPL2 according to the accumulated RF exposure of the RF sub-group 200_7, in order to determine an adjusted TX power limit ATPL2 of the RF sub-group 200_7.

After determining the adjusted TX power limit ATPL2, the processing circuit 16 may control an instantaneous power of the RF sub-group 200_7 to make an average power of the RF sub-group 200_7 lower than or equal to the adjusted TX power limit ATPL2, in order to comply with regulations of the RF exposure limit TEL_2.

According to the adjusted TX power limits ATPL1 and ATPL2, the processing circuit 16 may determine the TX power limit of each active antenna among the active antennas (e.g., the antennas corresponding to the radio modules 12_1 and 12_2). Since related operations of the TX power limit are well known to those with ordinary knowledge in the art, and the focus of the present invention is on the mapping between the radio modules and the RF groups, the details of the related operations of the TX power limit will be omitted for brevity.

In some embodiments, the one or more messages MES may include some usage information of the electronic device 10, and the processing circuit 16 may dynamically separate one or more radio modules among the radio modules 12_1-12_M into one or more RF groups according to the usage information. The usage information may include one or more usage scenarios of the electronic device 10, including at least one of a state scenario, a gaming scenario, a phone call scenario, and a media streaming scenario, wherein the state scenario is related to an open state or a folded state of the electronic device 10.

For example, when the usage information indicates that the electronic device 10 is in the media streaming scenario, the processing circuit 16 may separate all of the radio modules 12_1-12_M into different RF groups in order to achieve the maximum throughput. When the usage information indicates that the electronic device 10 is in the gaming scenario, the processing circuit 16 may separate the radio modules 12_1-12_M for achieving a balance between the TX performance and the power saving. When the usage information indicates that the electronic device 10 is in the phone call scenario, the processing circuit 16 may separate the radio modules 12_1-12_M for achieving a balance between the phone call performance and the power saving. When the usage information indicates that the electronic device 10 is in the folded state, since there will be more overlap regions for the antenna configuration ANT_CON, the processing circuit 16 may reduce the number of RF groups. For another example, when the usage information indicates that the electronic device is on legs of a user, the processing circuit 16 may reduce the number of RF groups in order to save power.

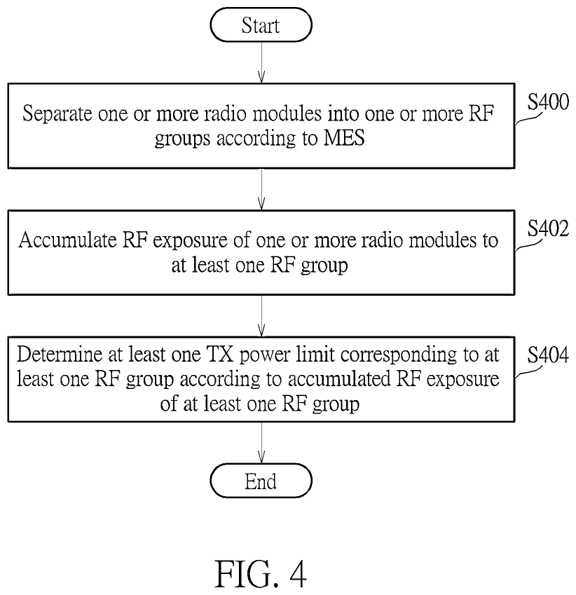

FIG. 4 is a flow chart of a method for performing mapping between one or more radio modules and one or more RF groups according to an embodiment of the present invention. Provided that the result is substantially the same, the steps are not required to be executed in the exact order shown in FIG. 4. For example, the method shown in FIG. 4 may be employed by the processing circuit 16 shown in FIG. 1.

In Step S400, one or more radio modules among the radio modules 12_1-12_M are separated into one or more RF groups according to the one or more messages MES.

In Step S402, RF exposure of the one or more radio modules is accumulated to at least one RF group among the one or more RF groups.

In Step S404, at least one TX power limit corresponding to the at least one RF group is determined according to accumulated RF exposure of the at least one RF group, for determining at least one TX power limit of at least one active antenna of the electronic device 10.

Since a person skilled in the pertinent art can readily understand details of the steps after reading above paragraphs directed to the processing circuit 16 shown in FIG. 1, further descriptions are omitted here for brevity.

In summary, by the method of the present invention and an associated electronic device, both the mapping between radio modules and RF groups and the RF exposure accumulation of the RF groups can be performed according to different body parts, which can optimize the performance of each RF group and guarantee the compliance of each RF group with RF exposure regulations. In addition, the radio modules may also be dynamically separated into the RF groups according to usage information of an electronic device, which can further optimize the performance of each RF group.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing mapping between one or more radio modules and one or more radiofrequency (RF) groups, wherein the one or more radio modules correspond to one or more antennas of an electronic device, respectively, and the method comprises:
separating the one or more radio modules into the one or more RF groups according to one or more messages, wherein the one or more messages comprise a previous transmitting (TX) power ratio, a TX power ratio margin, one or more weighting information, one or more TX performance indices, one or more receiving (RX) performance indices, one or more configurations, or one or more usage scenarios;
accumulating RF exposure of the one or more radio modules to at least one RF group among the one or more RF groups; and
determining at least one TX power limit corresponding to the at least one RF group according to accumulated RF exposure of the at least one RF group, for determining at least one TX power limit of at least one antenna among the one or more antennas.

2. The method of claim 1, wherein the one or more messages further comprise an antenna configuration, and the step of separating the one or more radio modules into the one or more RF groups according to the one or more messages further comprises:
separating the one or more radio modules into the one or more RF groups according to the antenna configuration.

3. The method of claim 2, wherein the antenna configuration is related to a specific absorption rate to peak location separation ratio (SPLSR).

4. The method of claim 1, wherein the one or more messages comprise the one or more TX performance indices, comprising at least one of a duty cycle of TX, an error vector magnitude (EVM) of TX, a target power, a throughput, a modulation and coding scheme (MCS), a block error rate (BLER), a resource block (RB), a transmission block size (TBS), and a TX packet error rate (TX PER).

5. The method of claim 1, wherein the one or more messages comprise the one or more RX performance indices, comprising at least one of a duty cycle of RX, a modulation and coding scheme (MCS), a block error rate (BLER), a resource block (RB), a received signal strength indication (RSSI), a reference signal RX power (RSRP), a signal to noise ratio (SNR), a signal to interference plus noise ratio (SINR), and an RX packet error rate (RX PER).

6. The method of claim 1, wherein the one or more messages comprise the one or more configurations related to at least one of one or more body-parts, a band, a beam, a technology, a sub-band, one or more exposure condition indices, a simultaneous transmitted state, a mobile country code (MCC), a mobile network code (MNC), a modulation, a bandwidth, a maximum power reduction (MPR), a path, a duty cycle, and a combination of the band and a subscriber identity module (SIM).

7. The method of claim 6, wherein the one or more messages comprise the one or more configurations related to the one or more body-parts; and the step of accumulating the RF exposure to the at least one RF group among the one or more RF groups comprises:
determining at least one active body part from the one or more body parts according to the one or more messages; and
accumulating the RF exposure to at least one active RF group corresponding to the at least one active body part, wherein the at least one active RF group is comprised in the one or more RF groups.

8. The method of claim 7, wherein the one or more body parts comprise a first body part and a second body part; and the step of determining the at least one active body part from the one or more body parts according to the one or more messages comprises:
in response to the first body part and the second body part being close to the electronic device, determining the first body part and the second body part as the at least one active body part.

9. The method of claim 8, wherein a first active RF group corresponds to the first body part, and a second active RF group corresponds to the second body part; and the step of accumulating the RF exposure to the at least one active RF group corresponding to the at least one active body part comprises:
simultaneously and separately accumulating the RF exposure to the first active RF group and the second active RF group.

10. The method of claim 1, wherein the one or more messages comprise the one or more usage scenarios comprise at least one of a state scenario, a gaming scenario, a phone call scenario, and a media streaming scenario; and the state scenario is related to an open state or a folded state of the electronic device.

11. An electronic device, comprising:
one or more antennas;
one or more radio modules, wherein the one or more radio modules correspond to the one or more antennas, respectively; and
a processing circuit, arranged to perform mapping between the one or more radio modules and one or more radiofrequency (RF) groups, wherein the processing circuit is further arranged to:
separate the one or more radio modules into the one or more RF groups according to one or more messages, wherein the one or more messages comprise a previous transmitting (TX) power ratio, a TX power ratio margin, one or more weighting information, one or more TX performance indices, one or more receiving (RX) performance indices, one or more configurations, or one or more usage scenarios;
accumulate RF exposure of the one or more radio modules to at least one RF group among the one or more RF groups; and
determine at least one TX power limit corresponding to the at least one RF group according to accumulated RF exposure of the at least one RF group, for determining at least one TX power limit of at least one antenna among the one or more antennas.

12. The electronic device of claim 11, wherein the one or more messages further comprise an antenna configuration, and the processing circuit is further arranged to:
separate the one or more radio modules into the one or more RF groups according to the antenna configuration.

13. The electronic device of claim 12, wherein the antenna configuration is related to a specific absorption rate to peak location separation ratio (SPLSR).

14. The electronic device of claim 11, wherein the one or more messages comprise the one or more TX performance indices, comprising at least one of a duty cycle of TX, an error vector magnitude (EVM) of TX, a target power, a throughput, a modulation and coding scheme (MCS), a block error rate (BLER), a resource block (RB), a transmission block size (TBS), and a TX packet error rate (TX PER).

15. The electronic device of claim 11, wherein the one or more messages comprise the one or more RX performance indices, comprising at least one of a duty cycle of RX, a modulation and coding scheme (MCS), a block error rate (BLER), a resource block (RB), a received signal strength indication (RSSI), a reference signal RX power (RSRP), a signal to noise ratio (SNR), a signal to interference plus noise ratio (SINR), and an RX packet error rate (RX PER).

16. The electronic device of claim 11, wherein the one or more messages comprise the one or more configurations related to at least one of one or more body-parts, a band, a beam, a technology, a sub-band, one or more exposure condition indices, a simultaneous transmitted state, a mobile country code (MCC), a mobile network code (MNC), a modulation, a bandwidth, a maximum power reduction (MPR), a path, a duty cycle, and a combination of the band and a subscriber identity module (SIM).

17. The electronic device of claim 16, wherein the one or more messages comprise the one or more configurations related to the one or more body-parts; and the processing circuit is further arranged to:
determine at least one active body part from the one or more body parts according to the one or more messages; and
accumulate the RF exposure to at least one active RF group corresponding to the at least one active body part, wherein the at least one active RF group is comprised in the one or more RF groups.

18. The electronic device of claim 17, wherein the one or more body parts comprise a first body part and a second body part; and in response to the first body part and the second body part being close to the electronic device, the processing circuit determines the first body part and the second body part as the at least one active body part.

19. The electronic device of claim 18, wherein a first active RF group corresponds to the first body part, and a second active RF group corresponds to the second body part; and the processing circuit simultaneously and separately accumulates the RF exposure to the first active RF group and the second active RF group.

20. The electronic device of claim 11, wherein the one or more messages comprise the one or more usage scenarios comprise at least one of a state scenario, a gaming scenario, a phone call scenario, and a media streaming scenario; and the state scenario is related to an open state or a folded state of the electronic device.
